(19) United States
(12) Patent Application Publication
(10) Pub. No.: US 2010/0269865 A1
(43) Pub. Date: Oct. 28, 2010

(54) LIQUID PROCESSING APPARATUS AND LIQUID PROCESSING METHOD

(75) Inventor: Kenji SEKIGUCHI, Nirasaki City (JP)

Correspondence Address: CANTOR COLBURN, LLP, 20 Church Street, 22nd Floor, Hartford, CT, 06103, US

(73) Assignee: TOKYO ELECTRON LIMITED, Tokyo (JP)

(21) Appl. No.: 12/763,379

(22) Filed: Apr. 20, 2010

(30) Foreign Application Priority Data
Apr. 22, 2009 (JP) 2009-103767

(51) Int. Cl. B08B 3/00

(52) U.S. Cl. 134/30; 134/95.2

(57) ABSTRACT

Disclosed is a liquid processing apparatus which can more securely prevent convex portions from collapsing and also can increase the processing efficiency of a substrate. The liquid processing apparatus processes the substrate having a main body part, and a plurality of convex portions provided on the main body part. The liquid processing apparatus includes a supporting part to support the main body part of the substrate, a chemical liquid supply mechanism to supply a chemical liquid to the substrate supported by the supporting part, and a rinsing liquid supply mechanism to supply a rinsing liquid to the substrate to which the chemical liquid has been supplied by the chemical liquid supply mechanism. Also, the liquid processing apparatus includes a hydrophobicizing gas supply mechanism to inject and supply a hydrophobicizing gas to the substrate to which the rinsing liquid has been supplied by the rinsing liquid supply mechanism.

This application is based on and claims priority from Japanese Patent Application No. 2009-103767, filed on Apr. 22, 2009, with the Japanese Patent Office, the disclosure of which is incorporated herein in its entirety by reference.

### TECHNICAL FIELD

The present disclosure relates to a liquid processing apparatus and a liquid processing method, which is to process a substrate having a main body part, and a plurality of convex portions provided on the main body part.

### BACKGROUND

There has been conventionally known a liquid processing method, which includes a step of rinsing, by using a rinsing liquid such as deionized water, a semiconductor substrate having a plurality of micro protrusion lines (convex portions) formed as a fine pattern on a surface of a main body part of the semiconductor substrate, and a step of drying the semiconductor substrate, after the rinsing step.

However, in such a liquid processing method, when the rinsing liquid supplied to the semiconductor substrate is dried out, the rinsing liquid's surface tension between the protrusion lines formed on the main body part of the substrate may result in an elongation and collapse of adjacent protrusion lines.

Accordingly, in order to prevent such a collapse in the protrusion lines, an attempt to carry out a hydrophobicizing treatment has been made, in which a hydrophobicizing liquid is supplied to the protrusion lines formed as a fine pattern, prior to a rinsing step on a semiconductor substrate. See, for example, Japanese Patent Laid-open Publication No. HEI 7-273083.

However, the hydrophobicizing treatment using a hydrophobicizing liquid increases the number of required processes and reduces the processing efficiency of the substrate. Also, the required amount of an expensive hydrophobicizing liquid is increased.

### SUMMARY

According to an exemplary embodiment, there is provided a liquid processing apparatus to process a substrate having a main body part, and a plurality of convex portions provided on the main body part, the liquid processing apparatus includes a supporting part to support the main body part of the substrate, a chemical liquid supply mechanism to supply a chemical liquid to the substrate supported by the supporting part, a rinsing liquid supply mechanism to supply a rinsing liquid to the substrate to which the chemical liquid has been supplied by the chemical liquid supply mechanism, and a hydrophobicizing gas supply mechanism to inject and supply a hydrophobicizing gas to the substrate to which the rinsing liquid has been supplied by the rinsing liquid supply mechanism.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a lateral cross-sectional view illustrating the configuration of a liquid processing apparatus according to a first exemplary embodiment of the present disclosure.

FIG. 2 is a top plan view illustrating the configuration of a liquid processing apparatus according to a first exemplary embodiment of the present disclosure.

FIG. 3 is a lateral cross-sectional view illustrating the configuration of a hydrophobicizing gas supply mechanism, and the neighborhood of a carrier gas supply device, according to a first exemplary embodiment of the present disclosure.

FIGS. 4a, 4b, 4c each is a lateral cross-sectional view illustrating an aspect of the processing by a liquid processing method according to a first exemplary embodiment of the present disclosure.

FIGS. 5a, 5b each is a lateral cross-sectional view illustrating an application effect of a liquid processing method according to a first exemplary embodiment of the present disclosure.

FIGS. 6a, 6b each is a lateral cross-sectional view illustrating the configuration of a hydrophobicizing gas supply mechanism, and the neighborhood of a carrier gas supply device, according to one modified embodiment of a first exemplary embodiment of the present disclosure.

FIG. 7 is a top plan view illustrating the configuration of a liquid processing apparatus according to a modified embodiment of a first exemplary embodiment of the present disclosure.

FIG. 8 is a computer system that can be connected to a liquid processing apparatus according to an exemplary embodiment of the present disclosure.

FIG. 9 is a top plan view illustrating the configuration of a liquid processing apparatus according to a second exemplary embodiment of the present disclosure.

FIG. 10 is a lateral cross-sectional view illustrating an aspect of the processing on the substrate conducted by a conventional liquid processing method.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented here.

The present disclosure provides a liquid processing apparatus and a liquid processing method, which can prevent the convex portions from collapsing and increase the processing efficiency of the substrate.

According to an exemplary embodiment, there is provided a liquid processing apparatus to process a substrate having a main body part, and a plurality of convex portions provided on the main body part. The liquid processing apparatus includes a supporting part to support the main body part of the substrate, a chemical liquid supply mechanism to supply a chemical liquid to the substrate supported by the supporting part, a rinsing liquid supply mechanism to supply a rinsing liquid to the substrate to which the chemical liquid has been supplied by the chemical liquid supply mechanism, and a hydrophobicizing gas supply mechanism to inject and supply a hydrophobicizing gas to the substrate to which the rinsing liquid has been supplied by the rinsing liquid supply mechanism.

The liquid processing apparatus according to the exemplary embodiment may further comprises a moving mechanism to relatively move the hydrophobicizing gas supply mechanism with respect to the substrate, and a moving mechanism to relatively move the rinsing liquid supply mechanism and the hydrophobicizing gas supply mechanism with respect to the substrate. In particular, the moving mechanism includes a rinsing liquid moving part to relatively move the rinsing liquid supply mechanism with respect to the substrate, and a hydrophobicizing gas moving part to relatively move the hydrophobicizing gas supply mechanism with respect to the substrate, and the rinsing liquid moving part and the hydrophobicizing gas moving part move the rinsing liquid supply mechanism and the hydrophobicizing gas supply mechanism simultaneously.

The liquid processing apparatus according to the exemplary embodiment may further comprises a rotation driving mechanism to rotate the substrate through rotation of the supporting part on a rotation shaft, the moving mechanism moves the rinsing liquid supply mechanism and the hydrophobicizing gas supply mechanism simultaneously in a direction perpendicular to the rotation shaft, and the rinsing liquid supply mechanism and the hydrophobicizing gas supply mechanism are positioned in such a way that the hydrophobicizing gas is supplied nearer to a rotational center side of the substrate than the rinsing liquid while the rinsing liquid supply mechanism and the hydrophobicizing gas supply mechanism move from rotational center toward circumferential periphery of the substrate. Also, the hydrophobicizing gas supply mechanism includes a hydrophobicizing gas heating part to supply a heated hydrophobicizing gas from the hydrophobicizing gas supply mechanism.

The liquid processing apparatus according to the exemplary embodiment may further comprises a carrier gas supply part to mix a carrier gas with the hydrophobicizing gas and to supply a mixed gas of the hydrophobicizing gas and the carrier gas to the substrate. Moreover, the liquid processing apparatus further comprises a carrier gas heating part to heat the carrier gas supplied from the carrier gas supply part, a mixed gas heating part to heat the mixed gas of the hydrophobicizing gas and the carrier gas, and an ultraviolet irradiation mechanism to irradiate ultraviolet rays to the substrate to which the hydrophobicizing gas has been supplied by the hydrophobicizing gas supply mechanism.

The liquid processing apparatus according to the exemplary embodiment may further comprises an ultraviolet irradiation mechanism to irradiate ultraviolet rays to the substrate to which the hydrophobicizing gas has been supplied by the hydrophobicizing gas supply mechanism, and a moving mechanism to relatively move at least the hydrophobicizing gas supply mechanism and the ultraviolet irradiation mechanism with respect to the substrate, wherein the moving mechanism moves the hydrophobicizing gas supply mechanism and the ultraviolet irradiation mechanism simultaneously.

According to another exemplary embodiment of the present disclosure, there is provided a liquid processing method to process a substrate having a main body part, and a plurality of convex portions provided on the main body part, the liquid processing method including supporting the substrate by a supporting part, supplying a chemical liquid to the substrate supported by the supporting part, by a chemical liquid supply mechanism, supplying a rinsing liquid to the substrate to which the chemical liquid has been supplied by the chemical liquid supply mechanism, by a rinsing liquid supply mechanism, and injecting and supplying a hydrophobicizing gas to the substrate to which the rinsing liquid has been supplied by the rinsing liquid supply mechanism, by a hydrophobicizing gas supply mechanism. In particular, the hydrophobicizing gas supply mechanism is relatively moved with respect to the substrate by a moving mechanism.

According to yet another exemplary embodiment, there is provided a liquid processing apparatus to process a substrate having a main body part, and a plurality of convex portions provided on the main body part, the liquid processing apparatus comprises means for supporting to support the main body part of the substrate, means for supplying a chemical liquid to supply the chemical liquid to the substrate supported by the means for supporting, means for supplying a rinsing liquid to supply the rinsing liquid to the substrate to which the chemical liquid has been supplied by the means for supplying a chemical liquid, and means for supplying a hydrophobicizing gas to inject and supply a hydrophobicizing gas to the substrate to which the rinsing liquid has been supplied by the means for supplying a rinsing liquid. In particular, the liquid processing apparatus further comprises means for moving to relatively move the means for supplying a hydrophobicizing gas with respect to the substrate. Also, the liquid processing apparatus further comprises means for moving to relatively move the means for supplying a rinsing liquid and the means for supplying a hydrophobicizing gas with respect to the substrate.

In the present disclosure, a hydrophobicizing gas is injected and supplied to the substrate to which a rinsing liquid has been supplied. Thus, it is possible to more securely prevent convex portions from collapsing. Also, the use of such a hydrophobicizing gas can increase the processing efficiency of the substrate.

### First Exemplary Embodiment

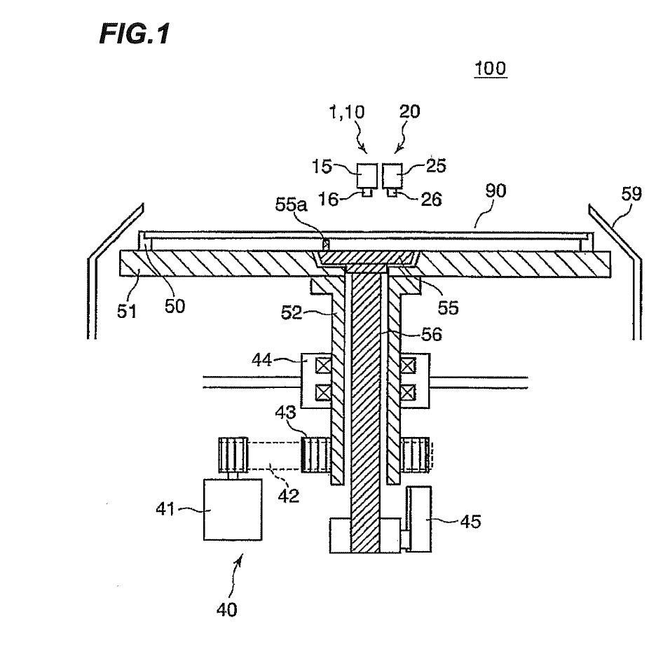

Hereinafter, a liquid processing apparatus and a liquid processing method will be described with reference to the drawings, according to a first exemplary embodiment of the present disclosure. Herein, FIGS. 1 through 7 are views showing the first exemplary embodiment of the present disclosure.

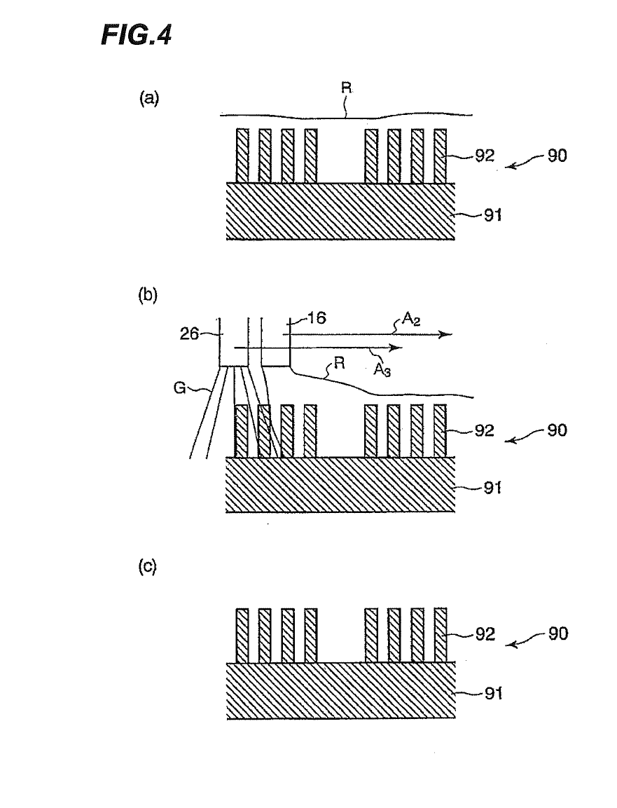

A liquid processing apparatus 100 is used for processing a substrate 90 having a substrate main body part (main body part) 91, and a plurality of convex portions 92 provided on substrate main body part 91, as illustrated in FIGS. 4a through 4c. Also, convex portions 92 are formed with a predetermined pattern on substrate main body part 91. Also, substrate 90 may be a semiconductor substrate such as a semiconductor wafer.

Also, as shown in FIG. 1, liquid processing apparatus 100 includes a hollow structural support plate 51, a hollow structural rotation shaft 52, a lift pin plate 55, a lift shaft 56, and a lift driving part 45. Support plate 51 has a supporting part 50 which maintains and supports substrate main body part 91 of substrate 90. Rotation shaft 52 is connected to the lower surface of support plate 51 and extendable in upward and downward directions. Lift pin plate 55 is disposed within the hollow of support plate 51 and has a lift pin 55a capable of contacting with the back surface (a lower surface) of substrate 90. Lift shaft 56 is connected to the lower surface of lift pin plate 55 and extends in upward and downward directions within the hollow of rotation shaft 52. Lift driving part 45 raises and lowers lift shaft 56 in upward and downward directions. Also, a cup 59 is provided at the outside of the circumferential periphery of support plate 51, which is for covering the circumferential periphery of substrate 90 supported by supporting part 50, and the upper portion of the inclined periphery. Also, although only one lift pin 55a is shown in FIG. 1, three lift pins 55a are actually provided in lift pin plate 55 in the present exemplary embodiment.

Also, as shown in FIG. 1, liquid processing apparatus 100 further includes a rotation driving mechanism 40 having a pulley 43 and a motor 41. Pulley 43 is disposed at the outside of the circumferential periphery of rotation shaft 52, and motor 41 provides a driving power to pulley 43 through a drive belt 42. Rotation driving mechanism 40 is configured in such a way that motor 41 rotates supporting part 50 around rotation shaft 52 through the rotation of rotation shaft 52, thereby rotating substrate 90 maintained and supported by supporting part 50. Also, a bearing 44 is disposed at the outside of the circumferential periphery of rotation shaft 52.

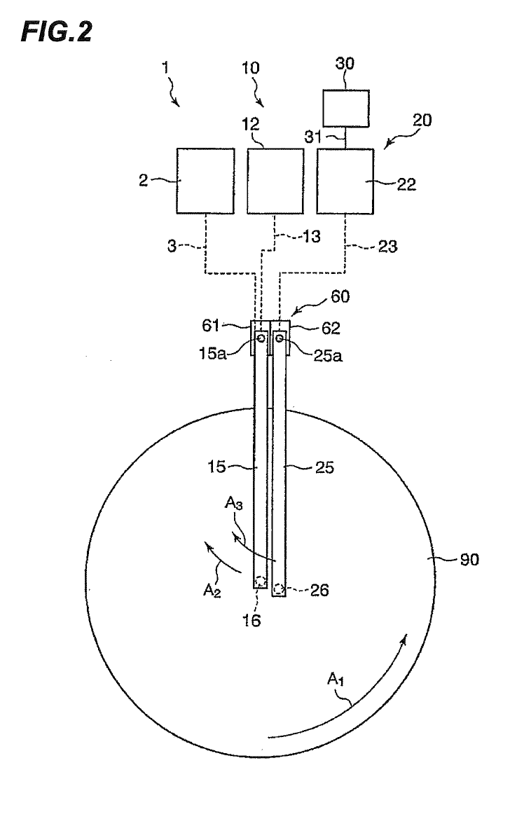

Also, as shown in FIG. 2, liquid processing apparatus 100 also includes a chemical liquid supply mechanism 1, a rinsing liquid supply mechanism 10, and a hydrophobicizing gas supply mechanism 20. Chemical liquid supply mechanism 1 supplies a chemical liquid to substrate 90 supported by supporting part 50. Rinsing liquid supply mechanism 10 supplies a rinsing liquid R, as shown in FIG. 4a, to substrate 90 to which the chemical liquid has been supplied by chemical liquid supply mechanism 1. Hydrophobicizing gas supply mechanism 20 injects and supplies a hydrophobicizing gas to substrate 90, to which rinsing liquid R has been supplied by rinsing liquid supply mechanism 10. Also, in the present exemplary embodiment, a mixed gas G that includes the hydrophobicizing gas mixed with a carrier gas is injected and supplied to substrate 90, as shown in FIG. 4b.

Also, as shown in FIG. 2, chemical liquid supply mechanism 1 has a chemical liquid supply part 2 for supplying a chemical liquid, a chemical liquid supply tube 3, a liquid supply arm 15, and a liquid supply nozzle 16. Chemical liquid supply tube 3 guides the chemical liquid supplied from chemical liquid supply part 2. A part of chemical liquid supply tube 3 passes through liquid supply arm 15. Liquid supply nozzle 16 is provided at the end portion of liquid supply arm 15. Also, examples of the chemical liquid used for the present exemplary embodiment may include sulfuric acid-hydrogen peroxide solution, ammonia-hydrogen peroxide solution, diluted hydrofluoric acid, but the present disclosure is not limited thereto.

Also, as shown in FIG. 2, rinsing liquid supply mechanism 10 has a rinsing liquid supply part 12 for supplying rinsing liquid R, a rinsing liquid supply tube 13, liquid supply arm 15, and liquid supply nozzle 16. Rinsing liquid supply tube 13 guides rinsing liquid R supplied from rinsing liquid supply part 12. A part of rinsing liquid supply tube 13 passes through liquid supply arm 15. Liquid supply nozzle 16 is provided at the end portion of liquid supply arm 15. Also, although in the present exemplary embodiment, liquid supply arm 15, and liquid supply nozzle 16 are described as configuration components for both of chemical liquid supply mechanism 1 and rinsing liquid supply mechanism 10, the present disclosure is not limited thereto. Also, examples of rinsing liquid R used for the present exemplary embodiment may include deionized water DIW, but the present disclosure is not limited thereto.

Also, as shown in FIG. 2, hydrophobicizing gas supply mechanism 20 has a hydrophobicizing gas supply device 22 for supplying a hydrophobicizing gas, a gas supply tube 23, a gas supply arm 25, and a gas supply nozzle 26. Gas supply tube 23 guides the hydrophobicizing gas supplied from hydrophobicizing gas supply device 22. A part of gas supply tube 23 passes through gas supply arm 25. Gas supply nozzle 26 is provided at the end portion of gas supply arm 25. Also, examples of the hydrophobicizing gas used for the present exemplary embodiment may include a silylating agent (such as dimethylaminotrimethylsilane (TMSDMA), dimethyl(dimethylamino)silane (DMSDMA), 1,1,3,3-tetramethyldisilane (TMDS), and hexamethyldisilazane (HMDS)), a surfactant, a fluoropolymer, but the present disclosure is not limited thereto.

Also, as shown in FIG. 2, liquid processing apparatus 100 further includes a moving mechanism 60 which moves chemical liquid supply mechanism 1, rinsing liquid supply mechanism 10, and hydrophobicizing gas supply mechanism 20, with respect to substrate 90.

Moving mechanism 60 has a liquid supply arm moving part (a rinsing liquid moving part) 61, and a gas supply arm moving part (a hydrophobicizing gas moving part) 62. Liquid supply arm moving part 61 swing liquid supply arm 15 of rinsing liquid supply mechanism 10 in the horizontal direction, which is perpendicular to rotation shaft 52, around a swinging shaft 15a. Gas supply arm moving part 62 swing gas supply arm 25 of hydrophobicizing gas supply mechanism 20 in the horizontal direction, which is perpendicular to rotation shaft 52, around a swinging shaft 25a. Also, each of liquid supply arm moving part 61 and gas supply arm moving part 62 is configured to selectively swing liquid supply arm 15 and gas supply arm 25, respectively, and can individually or simultaneously swung liquid supply arm 15 and gas supply arm 25. Also, although a configuration where liquid supply arm 15 and gas supply arm 25 are separately provided is used in the above described aspect of the present exemplary embodiment, the present disclosure is not limited thereto. For example, liquid supply arm 15 and gas supply arm 25 may be integrated and a single arm may function as both liquid supply arm 15 and gas supply arm 25.

Also, the positional relationship between liquid supply nozzle 16 and gas supply nozzle 26 is configured in such a way that mixed gas G is supplied nearer to the rotational center side of substrate 90 than the supply position of rinsing liquid R, while liquid supply nozzle 16 and gas supply nozzle 26 move from the rotational center of substrate 90 toward the circumferential periphery, as shown in FIG. 2.

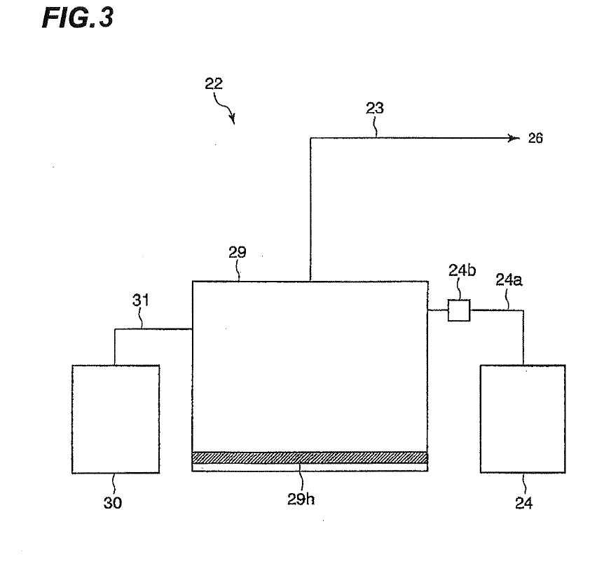

Also, hydrophobicizing gas supply mechanism 20 has a hydrophobicizing gas heating part 29h to supply a heated hydrophobicizing gas from hydrophobicizing gas supply mechanism 20. Specifically, as shown in FIG. 3, hydrophobicizing gas supply device 22 of hydrophobicizing gas supply mechanism 20 has a hydrophobicizing liquid supply part 24, a hydrophobicizing liquid supply tube 24a, and hydrophobicizing gas heating part 29h. Hydrophobicizing liquid supply part 24 supplies a hydrophobicizing liquid which is a hydrophobicizing gas in a liquefied state. Hydrophobicizing liquid supply tube 24a guides the hydrophobicizing liquid supplied from hydrophobicizing liquid supply part 24. Hydrophobicizing gas heating part 29h heats and evaporates the hydrophobicizing liquid passed through hydrophobicizing liquid supply tube 24a, thereby generating a high temperature hydrophobicizing gas. Also, hydrophobicizing liquid supply tube 24a is provided with a flow control part 24b which controls the amount of the hydrophobicizing liquid supplied from hydrophobicizing liquid supply part 24. Also, hydrophobicizing gas heating part 29h is disposed within a gas supply case 29 connected to gas supply tube 23.

Also, as shown in FIG. 3, gas supply case 29 is connected to a carrier gas supply part 30 via a carrier gas supply tube 31. Carrier gas supply part 30 mixes a carrier gas, such as N₂ or Ar, with a hydrophobicizing gas. The carrier gas supplied from carrier gas supply part 30 is mixed with a high temperature hydrophobicizing gas evaporated from the hydrophobicizing liquid so as to generate mixed gas G. Mixed gas G is supplied to substrate 90 via gas supply tube 23 and gas supply nozzle 26.

Hereinafter, the operation of the present exemplary embodiment having the above described configuration will be described.

First, as shown in FIG. 1, lift pin plate 55 is positioned at an upper position by lift driving part 45, that is, a position to which a carrying robot (not shown) transfers substrate 90 (an upper position determining step).

Next, three lift pins 55a of lift pin plate 55 take substrate 90 from the carrying robot, and support the back surface (lower surface) of substrate 90 (a taking step).

Next, by lift driving part 45, lift pin plate 55 is positioned at a lower position in which substrate 90 is processed by a chemical liquid (a lower position determining step).

While lift pin plate 55 is positioned at the lower position as described above, supporting part 50 of support plate 51 maintains and supports substrate main body part 91 of substrate 90 (a supporting step)(see FIG. 1). Herein, substrate 90 is positioned in such a way that convex portions 92 are positioned at an upper side, and substrate main body part 91 is positioned at a lower side, as illustrated in FIGS. 4a through 4c.

Next, rotation shaft 52 is rotationally driven by motor 41, thereby rotating substrate 90 maintained and supported by supporting part 50 of support plate 51 (a rotating step), as indicated by arrow A1 in FIG. 2. While substrate 90 rotates as described above, the following steps are performed.

First, a chemical liquid is supplied to substrate 90 by chemical liquid supply mechanism 1, as shown in FIG. 2 (a chemical liquid supplying step). That is, the chemical liquid is supplied from chemical liquid supply part 2 to chemical liquid supply tube 3, and the chemical liquid passed through chemical liquid supply tube 3 is supplied to the upper surface of substrate 90 from liquid supply nozzle 16.

Next, after the chemical liquid has been supplied to the surface of substrate 90 by chemical liquid supply mechanism 1, rinsing liquid R is supplied to the surface by rinsing liquid supply mechanism 10 in a state where convex portions 92 of substrate 90 are not exposed to the outside of liquid surface (a rinsing liquid supplying step), as illustrated in FIGS. 2 and 4a. As described above, since convex portions 92 are not exposed to the outside of the liquid surface, it is possible to prevent surface tension from acting between convex portions 92. Also, herein, rinsing liquid R is supplied from rinsing liquid supply part 12 to rinsing liquid supply tube 13, and rinsing liquid R passed through rinsing liquid supply tube 13 is supplied to the surface of substrate 90 via liquid supply nozzle 16.

Next, in a state where rinsing liquid R has been supplied to substrate 90 from liquid supply nozzle 16, liquid supply arm 15 starts to be swung in the horizontal direction by liquid supply arm moving part 61 in such a way that liquid supply nozzle 16 traces circular arcs from the center of substrate 90 toward the circumferential periphery. That is, a rinsing liquid moving step is started. See, for example, arrow A2 in FIGS. 2, and 4b.

Herein, after rinsing liquid R has been supplied to the surface of substrate 90, mixed gas G starts to be injected and supplied by hydrophobicizing gas supply mechanism 20. That is, a gas supplying step is started. Also, gas supply arm 25 starts to be swung in the horizontal direction by gas supply arm moving part 62 in such a way that gas supply nozzle 26 traces circular arcs toward the circumferential periphery of substrate 90. That is, a gas moving step is started. See, for example, arrow A3 in FIGS. 2 and 4b. Also, herein, gas supply nozzle 26 supplies mixed gas G to a position nearer to the rotational center side of substrate 90 than the supply position of rinsing liquid R on substrate 90 from liquid supply nozzle 16, while liquid supply nozzle 16 and gas supply nozzle 26 move from the rotational center toward the circumferential periphery of substrate 90.

However, while liquid supply arm 15 and gas supply arm 25 are swung in the same direction in the present embodiment as described above, the present disclosure is not limited thereto. For example, liquid supply arm 15 and gas supply arm 25 may be swung in an opposite directions. A substantially similar effect can be achieved in this case since substrate 90 rotates. In other words, in this case, gas supply nozzle 26 supplies mixed gas G to a position nearer to the rotational center side of substrate 90 than the supply position of rinsing liquid R on substrate 90 by liquid supply nozzle 16, while liquid supply nozzle 16 and gas supply nozzle 26 move from the rotational center of toward the circumferential periphery of substrate 90. Thus, it is possible to sequentially process substrate 90 from the center toward the circumferential periphery.

Hereinafter, general effects and phenomena during the rinsing liquid supplying step, the rinsing liquid moving step, the gas supplying step, and the gas moving step will be described.

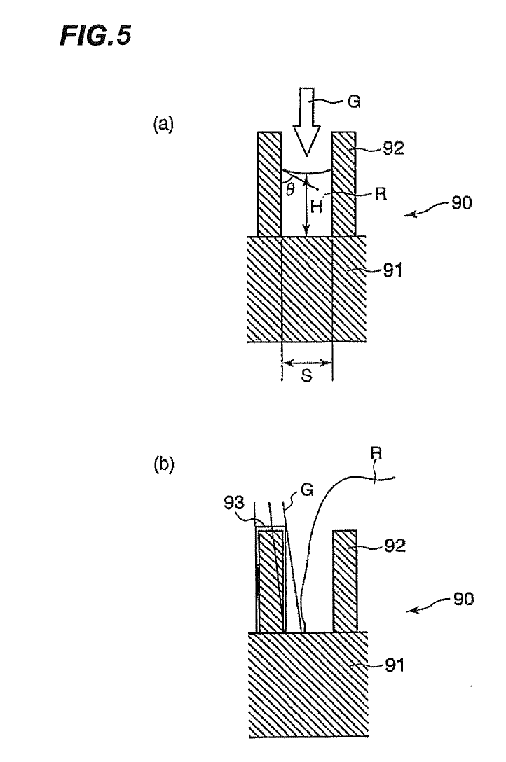

Also, a force F to collapse convex portions 92 is calculated using the following equation:

$$F = \frac{2 γcosθ}{S} HD \qquad ( 1 )$$

wherein γ denotes an interfacial tension between rinsing liquid R and convex portions 92, θ denotes an inclination angle of rinsing liquid R with respect to the lateral surface of convex portions 92, H denotes a height of liquid surface of rinsing liquid R between convex portions 92, D denotes a depth (not shown) of convex portions 92, and S denotes a space between convex portions 92, as illustrated in FIG. 5a.

First, hereinafter, the initial stage of the injection and supply of mixed gas G to the surface of substrate 90 will be described. At the initial stage of the injection and supply of mixed gas G, since mixed gas G is vigorously injected, it is possible to lower the level of a liquid surface in a state where θ value is close to 90° with respect to convex portions 92 of substrate 90, as shown in FIG. 5a. This may decrease the surface tension acting between convex portions 92.

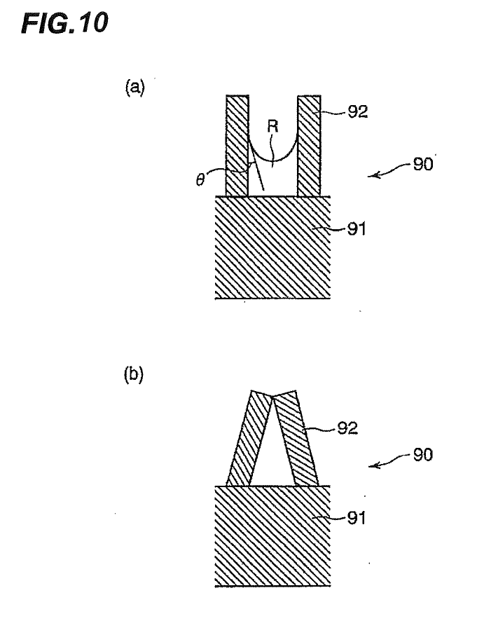

In other words, in a conventional case where a hydrophobicizing gas is not injected, since the level of a liquid surface of rinsing liquid R gets lowered slowly, θ value is decreased (cos θ value is increased) as shown in FIG. 10a, resulting in an increase in force F to collapse convex portions 92. This collapses convex portions 92 as shown in see FIG. 10b. In contrast, in the present exemplary embodiment, since mixed gas G can be vigorously injected, θ value can be maintained close to 90° (cos θ=0) as shown in FIG. 5a, resulting in a decrease in force F to collapse convex portions 92.

Hereinafter, the effects following the start of formation of a hydrophobicized surface 93 on the surface of substrate 90 by a hydrophobicizing gas will be described. After hydrophobicized surface 93 starts to be formed on the surface of substrate 90 as described above, hydrophobicized surface 93 is formed on at least one of adjacent convex portions 92. For this reason, even in a case where rinsing liquid R is splashed on convex portions 92 side formed with hydrophobicized surface 93, it is possible to prevent rinsing liquid R from residing over between convex portions 92 since rinsing liquid R bounces off. See, for example, FIG. 5b of the present disclosure. This is different from a case where an inert gas simply including N₂ or Ar, is sprayed. As a result, it is possible to prevent convex portions 92 from collapsing since the surface tension does not occur between convex portions 92.

Also, in the present exemplary embodiment, liquid supply nozzle 16 and gas supply nozzle 26 are simultaneously swung, and mixed gas G is supplied slightly nearer to the rotational center side of substrate 90 than the supply position of rinsing liquid R as illustrated in FIG. 4b. For this reason, hydrophobicized surface 93 is rapidly formed on at least one of adjacent convex portions 92, thereby preventing a surface tension from acting between convex portions 92.

Also, in the present exemplary embodiment, due to the injection of mixed gas G, an injection power of mixed gas G becomes stronger from a convex portion 92 side already formed with hydrophobicized surface 93 toward a convex portion 92 side where hydrophobicized surface 93 is not yet formed. This may prevent rinsing liquid R from moving to hydrophobicized convex portions 92 side as shown in FIG. 5b. For this reason, it is possible to more securely prevent rinsing liquid R from residing over between convex portions 92.

However, in a case where a silylating agent such as dimethylaminotrimethylsilane (TMSDMA) is used as a hydrophobicizing gas, a hydrophilic —OH group existing in the side surface of convex portions 92 is silylated, and, as a result, a hydrophobic trimethylsiloxy group [—OSi(CH₃)₃] is generated to carry out hydrophobicization and hydrophobicized surface 93 is formed.

Also, since the present exemplary embodiment utilizes the hydrophobicizing gas which is gasified with an increased volume, it is possible to reduce the required amount of a hydrophobicizing liquid which is expensive as compared to the required amount of hydrophobicizing liquid in a conventional technology. This may reduce the cost required for processing substrate 90.

Also, in the present exemplary embodiment, a mixed gas, where a carrier gas supplied from carrier gas supply part 30 is mixed with a hydrophobicizing gas, is supplied to substrate 90. For this reason, a strong injection power can be delivered to the surface of convex portions 92 even with a small amount of hydrophobicizing gas, thereby reducing the required amount of hydrophobicizing liquid.

Also, in the present exemplary embodiment, since substrate 90 can be hydrophobicized by a hydrophobicizing gas included in mixed gas G, and also can be dried out by mixed gas G, there is no need to provide a hydrophobicizing process separately as used for a conventional technology. For this reason, it is possible to increase the processing efficiency of substrate 90 compared to a conventional technology.

Also, in the present exemplary embodiment, it is possible to simultaneously swing liquid supply arm 15 and gas supply arm 25, thereby a cleaning of substrate 90 by rinsing liquid R, and hydrophobicizing/drying of substrate 90 by mixed gas G can be performed in parallel. This may further increase the processing efficiency of substrate 90.

Also, in the present exemplary embodiment, since a high temperature hydrophobicizing gas evaporated by heating of hydrophobicizing gas heating part 29h is used, it is possible to efficiently dry out the surface of substrate 90 by the high temperature mixed gas G. This may also increase the processing efficiency of substrate 90.

As described above, when gas supply nozzle 26 provided in gas supply arm 25 is moved to the end position by carrying out of the above described steps including rinsing liquid supplying step, rinsing liquid moving step, gas supplying step and gas moving step, the entire surface of substrate 90 is hydrophobicized and dried out, as illustrated in FIG. 4c. Then, the rotation of motor 41 is stopped, thereby stopping the rotation of substrate 90.

When the rotation of substrate 90 is stopped as described above, lift pin plate 55 is positioned at an upper position by lift driving part 45, and substrate 90 is raised by lift pins 55a (an upper position determining step). Then, substrate 90 is taken and drawn out by a carrying robot (a drawing-out step).

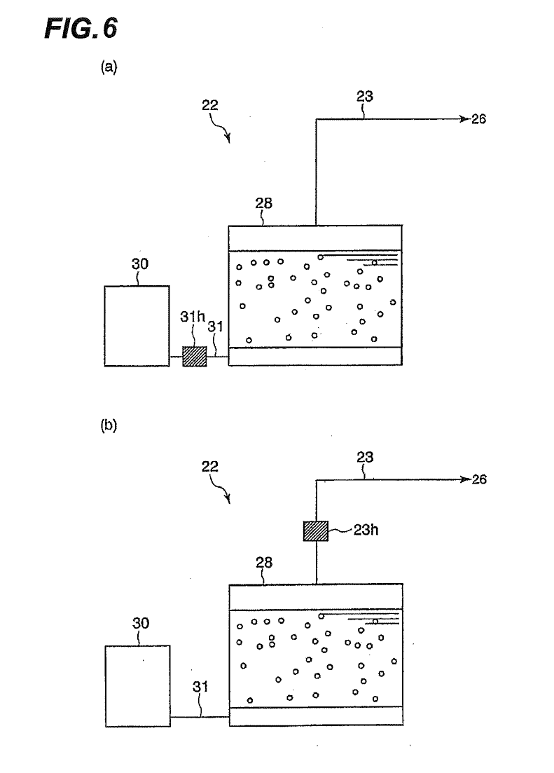

However, in the above described aspect of the present exemplary embodiment, hydrophobicizing gas supply device 22 of hydrophobicizing gas supply mechanism 20 has hydrophobicizing gas heating part 29h for heating a hydrophobicizing gas in order to supply high temperature mixed gas G to substrate 90. However, the present disclosure is not limited thereto. For example, in another embodiment, carrier gas supply tube 31 may be provided with a carrier gas heating part 31h for heating the carrier gas supplied to carrier gas supply tube 31 from carrier gas supply part 30, as shown in FIG. 6a. In yet another embodiment, gas supply tube 23 may be provided with a mixed gas heating part 23h for heating mixed gas G of a hydrophobicizing gas mixed with a carrier gas, as shown in FIG. 6b.

Also, in the above described aspect using carrier gas heating part 31h or mixed gas heating part 23h, hydrophobicizing gas supply mechanism 20 may have a reservoir case 28 for reserving a hydrophobicizing liquid, as shown in FIGS. 6a and 6b. Through the supply of the carrier gas into the hydrophobicizing liquid within reservoir case 28, mixed gas G of the hydrophobicizing gas and the carrier gas may be supplied to gas supply tube 23.

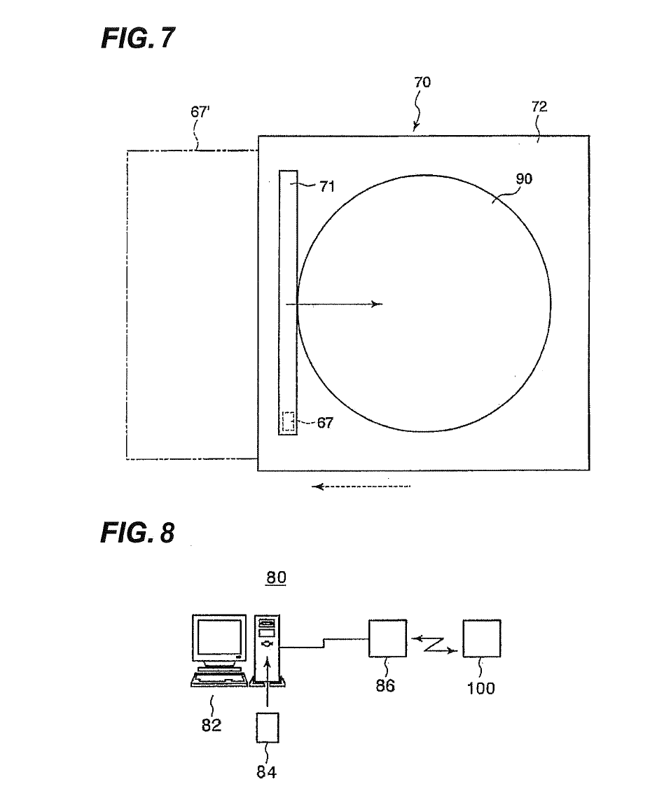

Also, in the present exemplary embodiment, liquid processing apparatus 100 may further include an ultraviolet irradiation mechanism 70 having an arranging table 72 and an ultraviolet irradiation part 71, as shown in FIG. 7. Arranging table 72 is to arrange substrate 90 drawn out in the drawing-out step to which a hydrophobicizing gas has been supplied by hydrophobicizing gas supply mechanism 20. Ultraviolet irradiation part 71 is to irradiate ultraviolet rays to substrate 90. Also, ultraviolet irradiation part 71 is provided with an ultraviolet moving part 67 for moving ultraviolet irradiation part 71 in the horizontal direction along the surface of substrate 90.

By the provision of ultraviolet irradiation mechanism 70, hydrophobicized surface 93 formed on the surface of substrate 90 may be removed, and particles including organic matter may be removed from substrate 90 as well.

Also, since ultraviolet irradiation part 71 needs to move relatively only with respect to substrate 90, the present disclosure is not limited to the above described aspect where ultraviolet irradiation part 71 is moved in the horizontal direction by ultraviolet moving part 67. Ultraviolet moving part 67′ for moving arranging table 72 in the horizontal direction may be used. See, for example, the two-dot chain line and the dotted arrow in FIG. 7.

Meanwhile, in the present exemplary embodiment, a computer program for executing the liquid processing method described above may be recorded in a recording medium 84 of computer system 80, as shown in FIG. 8. Also, computer system 80, connected with liquid processing apparatus 100, executes programs stored at recording medium 84, and executes a series of liquid processing steps required by the liquid processing method described above. Specifically, a controller 86 of computer system 80 may be connected to one of control points of liquid processing apparatus such as, for example, chemical liquid supply mechanism 1, rinsing liquid supply mechanism 10, hydrophobicizing gas supply mechanism 20, rotation driving mechanism 40, and lift driving part 45 of liquid processing apparatus 100, thereby driving liquid processing apparatus 100. Also, in the present disclosure, recording medium 84 may include, for example, compact disc (CD), Digital Video Disc (DVD), Magnetic Disc (MD), hard disc and Random Access Memory (RAM).

### Second Exemplary Embodiment

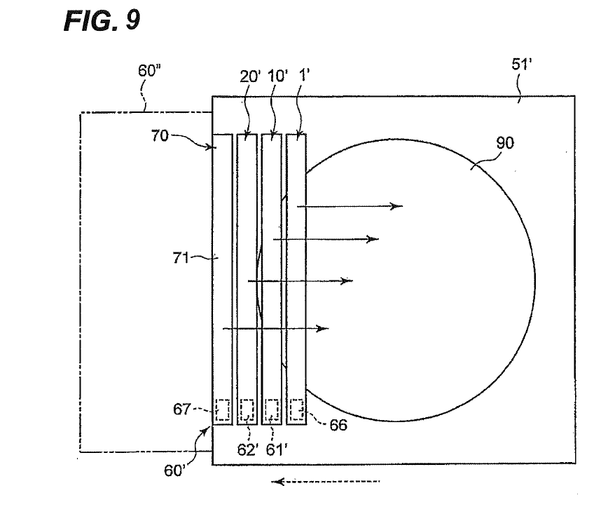

Hereinafter, a second exemplary embodiment of the present disclosure will be described with reference to FIG. 9. In the first exemplary embodiment shown in FIGS. 1 through 7, motor 41 rotates substrate 90 by rotating rotation shaft 52, liquid supply arm 15 is swung in the horizontal direction by liquid supply arm moving part (a rinsing liquid moving part) 61, and gas supply arm 25 is swung in the horizontal direction by gas supply arm moving part (a hydrophobicizing gas moving part) 62.

In contrast, in the second exemplary embodiment as shown in FIG. 9, a chemical liquid supply mechanism 1′ to supply a chemical liquid, a rinsing liquid supply mechanism 10′ to supply rinsing liquid R, and a hydrophobicizing gas supply mechanism 20′ to inject and supply a hydrophobicizing gas (or mixed gas G) are provided above substrate 90 positioned in such a way that convex portions 92 are positioned at the upper side and substrate main body part 91 is positioned at the lower side, and supported by a support plate 51′. Also, chemical liquid supply mechanism 1′ is provided with a chemical liquid moving part 66 for moving chemical liquid supply mechanism 1′ in the horizontal direction, rinsing liquid supply mechanism 10′ is provided with a rinsing liquid moving part 61′ for moving rinsing liquid supply mechanism 10′ in the horizontal direction, and hydrophobicizing gas supply mechanism 20′ is provided with a hydrophobicizing gas moving part 62′ for moving hydrophobicizing gas supply mechanism 20′ in the horizontal direction.

Also, in the present exemplary embodiment, ultraviolet irradiation mechanism 70 having ultraviolet irradiation part 71 for irradiating ultraviolet rays to substrate 90 is provided. Ultraviolet irradiation part 71 is provided with ultraviolet moving part 67 for moving ultraviolet irradiation part 71 in the horizontal direction. Also, chemical liquid moving part 66, rinsing liquid moving part 61′, hydrophobicizing gas moving part 62′, and ultraviolet moving part 67 constitute a moving mechanism 60′.

Each of chemical liquid moving part 66, rinsing liquid moving part 61′, hydrophobicizing gas moving part 62′, and ultraviolet moving part 67 constituting moving mechanism 60′ can simultaneously move chemical liquid supply mechanism 1′, rinsing liquid supply mechanism 10′, hydrophobicizing gas supply mechanism 20′, and ultraviolet irradiation mechanism 70, respectively, in the horizontal direction.

Other components are substantially similar to those in the first exemplary embodiment shown in FIGS. 1 through 7. Also, in the second exemplary embodiment shown in FIG. 9, substantially similar components to those in the first exemplary embodiment shown in FIGS. 1 to 7 are designated with the same reference numerals to omit repeated descriptions.

In the second exemplary embodiment, it is possible to achieve similar effects to those of the first exemplary embodiment. Some of major effects includes a firm prevention of convex portions 92 from collapsing, increasing the processing efficiency of substrate 90, and reducing the processing cost of substrate 90.

Also, according to the second exemplary embodiment, chemical liquid supply mechanism 1′, rinsing liquid supply mechanism 10′, hydrophobicizing gas supply mechanism 20′, and ultraviolet irradiation mechanism 70 simultaneously move simultaneously in the horizontal direction. Thus, it is possible to carry out various processes including cleaning of substrate 90 by a chemical liquid, rinsing of substrate 90 by rinsing liquid R, hydrophobicizing and drying of substrate 90 by a hydrophobicizing gas, and removing of hydrophobicized surface 93 and particles (including organic matter) from substrate 90 by ultraviolet rays, in parallel. Accordingly, it is possible to process substrate 90 with a high efficiency.

Also, chemical liquid supply mechanism 1′, rinsing liquid supply mechanism 10′, hydrophobicizing gas supply mechanism 20′, and ultraviolet irradiation mechanism 70 needs only to move relatively with respect to substrate 90. For this reason, a moving mechanism 60″ to move support plate 51 may be provided, illustrated as the two-dot chain line and the dotted arrow in FIG. 9, instead of chemical liquid moving part 66 for moving chemical liquid supply mechanism 1′, rinsing liquid moving part 61′ for moving rinsing liquid supply mechanism 10′, hydrophobicizing gas moving part 62′ for moving hydrophobicizing gas supply mechanism 20′, and ultraviolet moving part 67 for moving ultraviolet irradiation part 71, as described above. In this case, moving mechanism 60″ constitutes chemical liquid moving part 66, rinsing liquid moving part 61′, hydrophobicizing gas moving part 62′, and ultraviolet moving part 67.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

What is claimed is:

1. A liquid processing apparatus to process a substrate having a main body part, and a plurality of convex portions provided on the main body part, the liquid processing apparatus comprising:
a supporting part to support the main body part of the substrate;
a chemical liquid supply mechanism to supply a chemical liquid to the substrate supported by the supporting part;
a rinsing liquid supply mechanism to supply a rinsing liquid to the substrate to which the chemical liquid has been supplied by the chemical liquid supply mechanism; and
a hydrophobicizing gas supply mechanism to inject and supply a hydrophobicizing gas to the substrate to which the rinsing liquid has been supplied by the rinsing liquid supply mechanism.

2. The liquid processing apparatus according to claim 1, further comprising a moving mechanism to relatively move the hydrophobicizing gas supply mechanism with respect to the substrate.

3. The liquid processing apparatus according to claim 1, further comprising a moving mechanism to relatively move the rinsing liquid supply mechanism and the hydrophobicizing gas supply mechanism with respect to the substrate.

4. The liquid processing apparatus according to claim 3, wherein the moving mechanism includes a rinsing liquid moving part to relatively move the rinsing liquid supply mechanism with respect to the substrate, and a hydrophobicizing gas moving part to relatively move the hydrophobicizing gas supply mechanism with respect to the substrate, and
the rinsing liquid moving part and the hydrophobicizing gas moving part move the rinsing liquid supply mechanism and the hydrophobicizing gas supply mechanism simultaneously.

5. The liquid processing apparatus according to claim 3, wherein the liquid processing apparatus further comprises a rotation driving mechanism to rotate the substrate through rotation of the supporting part on a rotation shaft,
the moving mechanism moves the rinsing liquid supply mechanism and the hydrophobicizing gas supply mechanism simultaneously in a direction perpendicular to the rotation shaft, and
the rinsing liquid supply mechanism and the hydrophobicizing gas supply mechanism are positioned in such a way that the hydrophobicizing gas is supplied nearer to a rotational center side of the substrate than the rinsing liquid while the rinsing liquid supply mechanism and the hydrophobicizing gas supply mechanism move from rotational center toward circumferential periphery of the substrate.

6. The liquid processing apparatus according to claim 1, wherein the hydrophobicizing gas supply mechanism includes a hydrophobicizing gas heating part to supply a heated hydrophobicizing gas from the hydrophobicizing gas supply mechanism.

7. The liquid processing apparatus according to claim 1, further comprising a carrier gas supply part to mix a carrier gas with the hydrophobicizing gas and to supply a mixed gas of the hydrophobicizing gas and the carrier gas to the substrate.

8. The liquid processing apparatus according to claim 7, further comprising a carrier gas heating part to heat the carrier gas supplied from the carrier gas supply part.

9. The liquid processing apparatus according to claim 7, further comprising a mixed gas heating part to heat the mixed gas of the hydrophobicizing gas and the carrier gas.

10. The liquid processing apparatus according to claim 1, further comprising an ultraviolet irradiation mechanism to irradiate ultraviolet rays to the substrate to which the hydrophobicizing gas has been supplied by the hydrophobicizing gas supply mechanism.

11. The liquid processing apparatus according to claim 1, further comprising an ultraviolet irradiation mechanism to irradiate ultraviolet rays to the substrate to which the hydrophobicizing gas has been supplied by the hydrophobicizing gas supply mechanism, and
a moving mechanism to relatively move at least the hydrophobicizing gas supply mechanism and the ultraviolet irradiation mechanism with respect to the substrate,
wherein the moving mechanism moves the hydrophobicizing gas supply mechanism and the ultraviolet irradiation mechanism simultaneously.

12. A liquid processing method to process a substrate having a main body part, and a plurality of convex portions provided on the main body part, the liquid processing method comprising:
supporting the substrate by a supporting part;
supplying a chemical liquid to the substrate supported by the supporting part, by a chemical liquid supply mechanism;
supplying a rinsing liquid to the substrate to which the chemical liquid has been supplied by the chemical liquid supply mechanism, by a rinsing liquid supply mechanism; and
injecting and supplying a hydrophobicizing gas to the substrate to which the rinsing liquid has been supplied by the rinsing liquid supply mechanism, by a hydrophobicizing gas supply mechanism.

13. The liquid processing method according to claim 12, wherein the hydrophobicizing gas supply mechanism is relatively moved with respect to the substrate by a moving mechanism.

14. A liquid processing apparatus to process a substrate having a main body part, and a plurality of convex portions provided on the main body part, the liquid processing apparatus comprising:
means for supporting to support the main body part of the substrate;
means for supplying a chemical liquid to supply the chemical liquid to the substrate supported by the means for supporting;
means for supplying a rinsing liquid to supply the rinsing liquid to the substrate to which the chemical liquid has been supplied by the means for supplying a chemical liquid; and
means for supplying a hydrophobicizing gas to inject and supply a hydrophobicizing gas to the substrate to which the rinsing liquid has been supplied by the means for supplying a rinsing liquid.

15. The liquid processing apparatus according to claim 14, further comprising means for moving to relatively move the means for supplying a hydrophobicizing gas with respect to the substrate.

16. The liquid processing apparatus according to claim 14, further comprising means for moving to relatively move the means for supplying a rinsing liquid and the means for supplying a hydrophobicizing gas with respect to the substrate.
